(19) United States
(12) Patent Application Publication
(10) Pub. No.: US 2008/0174744 A1
(43) Pub. Date: Jul. 24, 2008

(54) IMAGE DISPLAYING APPARATUS AND CONTROL METHOD THEREOF

(75) Inventor: Young-sik MYOUNG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/838,428

(22) Filed: Aug. 14, 2007

(30) Foreign Application Priority Data
Jan. 24, 2007 (KR) 10-2007-0007467

(51) Int. Cl. G03B 21/14

(52) U.S. Cl. 353/84

(57) ABSTRACT

An image displaying apparatus, includes: a light source which emits light; a wheel unit which comprises a color wheel rotating and having a plurality of color regions to convert light emitted by the light source into color light; a display unit which receives the color light converted by the plurality of color regions to display an image thereon; a power supply which supplies power to the light source and the wheel unit; and a controller which controls the rotation of the color wheel so that the plurality of color regions are synchronized with color information included in the image signal, and controls the power supply not to supply power to at least one of the light source and the wheel unit if the plurality of color regions are not synchronized with the color information for more than a reference time.

### CROSS-REFERENCE TO RELATED APPLICATIONS

This application claims priority from Korean Patent Application No. 10-2007-0007467, filed on Jan. 24, 2007, in the Korean Intellectual Property Office, the disclosure of which is incorporated herein by reference.

### BACKGROUND OF THE INVENTION

1. Field of the Invention

Apparatuses and methods consistent with the present invention relate to an image displaying apparatus and a control method thereof, and more particularly, to an image displaying apparatus which displays an image by projecting a color light passing through a color wheel, and a control method thereof.

2. Description of the Related Art

An image displaying apparatus such as a digital light processing (DLP) projector and a DLP projection TV includes a rotating color wheel. The image displaying apparatus selectively projects a color light which is emitted from a light source and travels through the color wheel to display an image according to an image signal.

The color wheel includes a plurality of color regions by which white light emitted from the light source becomes color light such as red, green and blue light. Only if each color region is synchronized with corresponding color information of the image signal during the rotation of the color wheel, the image is properly displayed on a screen. Thus, the rotation of the color wheel is controlled so that the color regions of the color wheel are synchronized with the corresponding color information of the image signal.

A phase-locked loop (PLL) technology may be employed in controlling the color wheel. The PLL technology monitors the rotation of the color wheel and compares a monitored rotation result with a reference signal to control a rotation speed and a phase of a motor which rotates the color wheel.

A photo reflector may be used to monitor the rotation of the color wheel, which detects a mark put on the rotating color wheel or a motor shaft driving the color wheel to collect information on the rotation speed and the phase of the color wheel.

In some cases, the color regions of the color wheel are maintained not to be synchronized with the corresponding color information of the image signal according to a driving state of the image displaying apparatus.

If a temperature rises to approximately 90° C. around the photo reflector, the photo reflector may malfunction due to the high temperature, thereby failing to determine the rotation speed and the phase of the color wheel. Then, the rotation speed and the phase of the motor driving the color wheel are not properly controlled, thereby the color wheel continuously being out of synchronization with the image signal.

If the color wheel is not synchronized with the image signal continuously, an element of the image displaying apparatus such as the color wheel may be damaged.

### SUMMARY OF THE INVENTION

Accordingly, it is an aspect of the present invention to provide an image displaying apparatus which prevents an element thereof from being damaged even if a color wheel is not synchronized with an image signal, and a control method thereof.

Additional aspects and/or advantages of the present invention will be set forth in unit in the description which follows and, in unit, will be obvious from the description, or may be learned by practice of the present invention.

The foregoing and/or other aspects of the present invention can be achieved by providing an image displaying apparatus, comprising: a light source which emits light; a wheel unit which comprises a color wheel rotating and having a plurality of color regions to convert light emitted by the light source into color light; a display unit which receives the color light converted by the plurality of color regions to display an image thereon; a power supply which supplies power to the light source and the wheel unit; and a controller which controls the rotation of the color wheel so that the color regions are synchronized with color information included in the image signal, and controls the power supply not to supply power to at least one of the light source and the wheel unit if the color regions are not synchronized with the color information for more than a predetermined reference time.

According to an aspect of the invention, the image displaying apparatus further comprises a detector which detects at least one of a frequency and a phase of the color wheel, wherein the controller determines that the color regions are not synchronized with the color information if the frequency and the phase of the color wheel are not detected.

According to an aspect of the invention, the reference time is 80 ms to 120 ms if the color wheel rotates 14,000 to 15,000 times/minute.

According to an aspect of the invention, the reference time does not include stabilization time due to change of an image signal source or a channel.

According to an aspect of the invention, the image displaying apparatus further comprises a signal processor which processes the image signal, and a digital micromirror device (DMD) which selectively projects the color light converted by the plurality of color regions according to the color information of the image signal processed by the signal processor, to the display unit, wherein the power supply supplies power to the signal processor and the DMD, and the controller controls the power supply not to supply power to at least one of the signal processor and the DMD if the color regions are not synchronized with the color information for more than the reference time.

The foregoing and/or other aspects of the present invention can be achieved by providing a method of controlling an image displaying apparatus which comprises a light source to emit light, a wheel unit having a color wheel rotating and having a plurality of color regions to convert the light emitted from the light source into color light, a display unit to receive the color light converted by the plurality of color regions and display an image thereon, and a power supply to supply power to the light source and the wheel unit, the method comprising: controlling the rotation of the color wheel so that the color regions are synchronized with color information included in an image signal; and controlling the power supply not to supply power to at least one of the light source, the wheel unit and the display unit if the color regions are not synchronized with the color information for more than a predetermined reference time.

According to an aspect of the invention, the controlling the projection of the color light comprises detecting at least one of a frequency and a phase of the color wheel, and determining that the color regions are not synchronized with the color information if the frequency and the phase of the color wheel are not detected.

According to an aspect of the invention, the reference time is 80 ms to 120 ms if the color wheel rotates 14,000 to 15,000 times/minute.

According to an aspect of the invention, the controlling the projection of the color light comprises the reference time which does not comprise stabilization time due to a change of an image signal source or a channel.

According to an aspect of the invention, the image displaying apparatus further comprises a signal processor which receives power from the power supply and processes the image signal, and a digital micromirror device (DMD) which receives power from the power supply and selectively projects color light converted by the plurality of color regions according to color information of the image signal processed by the signal processor, to the display unit, further comprising: controlling the power supply not to supply power to at least one of the signal processor and the DMD if the color regions are not synchronized with the color information for more than the reference time.

According to an aspect of the invention, the display apparatus is a digital light processing projector.

According to an aspect of the present invention the color information includes information about the plurality of color regions corresponding to red, green and blue.

According to an aspect of the present invention the rotation of the color wheel is about an axis parallel to a path of the light emitted by the light source.

According to an aspect of the present invention the color wheel includes a mark on a lateral side of the color wheel for detecting the rotation of the color wheel.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a block diagram of an image displaying apparatus according to an exemplary embodiment of the present invention;

FIG. 2 illustrates a color wheel and a detector of the image displaying apparatus according to the exemplary embodiment of the present invention; and

FIG. 3 is a flowchart which describes an operation of the image displaying apparatus according to the exemplary embodiment of the present invention.

### DETAILED DESCRIPTION OF EXEMPLARY EMBODIMENTS

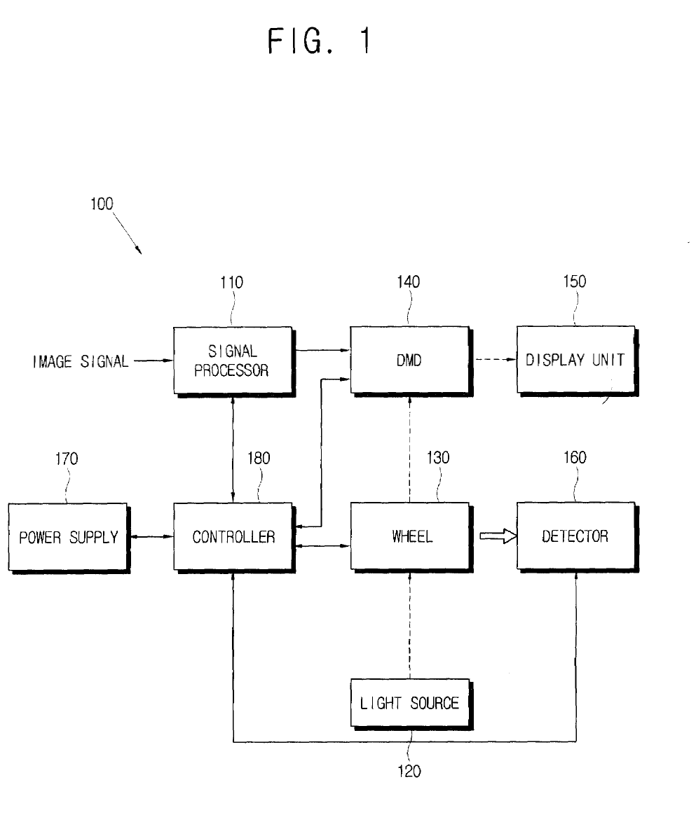

Hereinafter, exemplary embodiments of the present invention will be described with reference to accompanying drawings, wherein like numerals refer to like elements and repetitive descriptions will be avoided as necessary. FIG. 1 is a block diagram of an image displaying apparatus according to an exemplary embodiment of the present invention.

An image displaying apparatus 100 may include a digital light processing (DLP) projector and a DLP projection TV. The image displaying apparatus 100 may include a signal processor 110, a light source 120, a wheel unit 130, a digital micromirror device (DMD) 140, a display unit 150, a detector 160, a power supply 170 and a controller 180.

The signal processor 110 receives an image signal and processes the input image signal. The image signal input to the signal processor 110 includes image signals of an analog TV or a digital TV broadcasted by broadcasting stations, and image signals transmitted from image devices such as a DVD device and a computer system.

The signal processing conducted by the signal processor 110 includes tuning, decoding, A/D converting, modulating/demodulating, multiplexing/demultiplexing, deinterlacing, scaling, and image enhancing for the image signal. The signal processor 110 processes the image signal and outputs the image signal having color information on the region corresponding to red (R), green (G) and blue (B) colors.

The light source 120 outputs light to display an image. The light source 120 outputs white light and may include a fluorescent lamp.

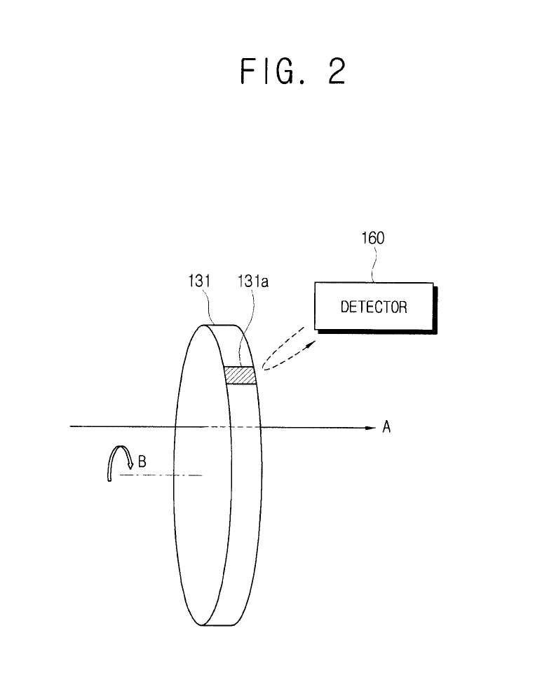

The wheel unit 130 filters the light output by the light source 120 and outputs color light. The wheel unit 130 may include a rotatable color wheel 131 (refer to FIG. 2) and a driving motor (not shown) to rotate the color wheel 131.

The color wheel 131 includes a plurality of color regions (not shown) which are divided corresponding to R, G and B colors. The light output from the light source 120 becomes color light through the color regions.

The DMD 140 selectively projects the color light output by the color wheel 131 to the display unit 150 based on the image signal processed by the signal processor 110. The DMD 140 includes a plurality of micromirrors (not shown) which reflect the color light output from the color wheel 131 corresponding to a plurality of pixels of an image, and selectively projects the color light to the display unit 150 by controlling an inclination of the plurality of micromirrors.

The display unit 150 is called a screen, and displays the image thereon by the color light reflected by the DMD 140.

The detector 160 detects the rotation speed and the phase of the color wheel 131 and transmits the detection result to the controller 180. FIG. 2 illustrates the color wheel 131 and the detector 160 of the image displaying apparatus 100 according to the exemplary embodiment of the present invention.

The color wheel 131 has a circular shape substantially, and rotates in a, e.g., direction B with respect to a light traveling path A. A mark 131a is formed in a lateral side of the color wheel 131 to detect the rotation thereof.

The detector 160 may include a photo reflector, and detects the light output by the photo reflector and reflected by the mark 131a of the color wheel 131 to collect information on the rotation of the color wheel 131.

The power supply 170 supplies power to the signal processor 110, the light source 120, the wheel unit 130 and the DMD 140 according to a control of the controller 180. FIG. 1 does not illustrate a power supply route of the power supply 170, as a matter of convenience.

The controller 180 controls the rotation of the color wheel unit 131 so that the plurality of color regions of the color wheel 131 is synchronized with the corresponding color information of the image signal. For example, the rotation speed and the phase of the color wheel 131 are controlled so that the light from the light source 120 passes through the color region corresponding to R of the color wheel 131 during the interval corresponding to R among the color information of the image signal.

The controller 180 controls the driving motor of the wheel 130 based on the information on the rotation speed and the phase of the color wheel 131 transmitted from the detector 160 so that the rotation speed (or rotation frequency) and the phase of the color wheel 131 are synchronized with a frequency and a phase of the color information of the image signal. A phase-locked loop (PLL) technology may be employed to control the rotation speed and the phase of the color wheel 131 (hereinafter, both to be called “phase”).

If the color wheel 131 is not synchronized with the corresponding image signal for a predetermined time, the controller 180 controls the power supply 170 to cut offpower supplied to the signal processor 110, the light source 120, the wheel unit 130 and the DMD 140.

That is, the controller 180 cuts off power supplied to the signal processor 110, the light source 120, the wheel 130 and the DMD 140 to prevent them from being damaged due to the failed synchronization between the color wheel 131 and the corresponding image signal.

If an image signal source is changed (e.g., from a DVD player to a computer system) or a channel is changed (e.g., from channel 7 to channel 9) while the color wheel 131 is not synchronized with the image signal, the controller 180 performs the synchronization process (hereinafter, to be called “stabilization”) of the color wheel 131 according to the changed image signal.

In this case, the controller 180 starts to count reference time after the time for stabilization (hereinafter, to be called “stabilization time”) of the color wheel 131 passes. That is, the reference time does not include the stabilization time of the color wheel 131.

If the information on the phase of the color wheel 131 is not transmitted from the detector 160, the controller 180 may determine that the color wheel 131 is not synchronized with the image signal.

For example, the detector 160 may not detect the mark 131a of the color wheel 131 due to high temperature. Then, the information on the phase of the color wheel 131 may not be collected.

If the color wheel 131 rotates 14,000 to 15,000 times/minute corresponding to the frequency of the image signal, the reference time may be a value in a range from approximately 80 ms to 120 ms.

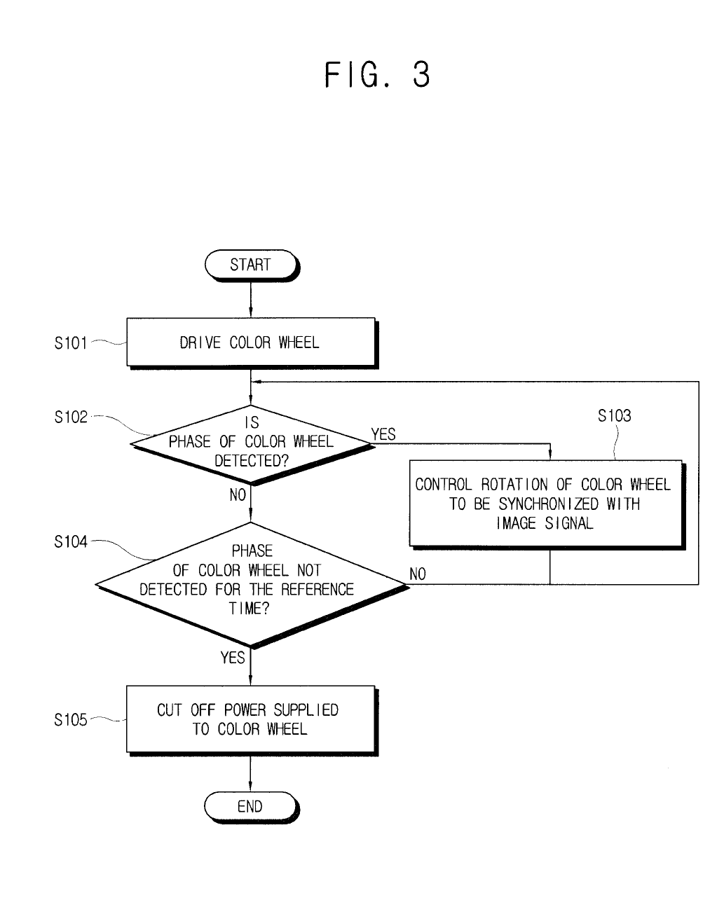

FIG. 3 is a flowchart which describes an operation of the image displaying apparatus 100 according to the exemplary embodiment of the present invention. First, the controller 180 controls the driving motor to rotate the color wheel 131 in a preset initial rotation value (S101).

Then, the controller 180 determines whether the phase of the color wheel 131 is detected through the detector 160 (S102). If it is determined at the operation of S102 that the detector 160 transmits the information on the phase of the color wheel 131, the controller 180 compares the transmitted information on the phase of the color wheel 131 with the frequency and the phase of the image signal to perform the synchronization process of the color wheel 131 (S103).

If it is determined at the operation of S102 that the detector 160 does not transmit the information on the phase of the color wheel 131, the controller 180 determines whether the phase of the color wheel 131 is not detected for the reference time (S104).

After the operation of S103 is performed or if a state that the phase of the color wheel 131 is not detected has not maintained for the reference time at the operation of S104, the operation of S102 is performed.

If a state that the phase of the color wheel 131 is not detected has not maintained for the reference time at the operation of S104, the controller 180 controls the power supply 170 to cut off power supplied to the color wheel 131, etc. (S105).

As described above, the present invention provides an image displaying apparatus which prevents an element thereof from being damaged by cutting off power supplied to the element even if a color wheel is not synchronized with an image signal for predetermined time depending on a state of the image displaying apparatus, and a control method thereof.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

1. An image displaying apparatus, comprising:
a light source which emits light;
a wheel unit which comprises a color wheel rotating and having a plurality of color regions to convert light emitted by the light source into color light;
a display unit which receives the color light to display an image;
a power supply which supplies power to at least one of the light source and the wheel unit; and
a controller which controls a rotation of the color wheel so that the plurality of color regions are synchronized with color information included in an image signal, and controls the power supply not to supply power to at least one of the light source and the wheel unit if the plurality of color regions are not synchronized with the color information for more than a reference time.

2. The image displaying apparatus according to claim 1, further comprising:
a detector which detects at least one of a frequency and a phase of the color wheel,
wherein the controller determines that the plurality of color regions are not synchronized with the color information if the frequency and the phase of the color wheel are not detected.

3. The image displaying apparatus according to claim 2, wherein the reference time is in a range from 80 ms to 120 ms if the color wheel rotates 14,000 to 15,000 times per minute.

4. The image displaying apparatus according to claim 1, wherein the reference time does not include stabilization time due to a change of an image signal source or a channel.

5. The image displaying apparatus according to claim 1, further comprising:
a signal processor which processes the image signal, and
a digital micromirror device (DMD) which selectively projects the color light based on the color information included in the image signal processed by the signal processor, to the display unit,
wherein the power supply supplies power to the signal processor and the DMD, and the controller controls the power supply not to supply power to at least one of the signal processor and the DMD if the plurality of color regions are not synchronized with the color information for more than the reference time.

6. A method of displaying an image, the method comprising:
emitting light from a light source toward a wheel unit;
converting the emitted light into color light at the wheel unit including a color wheel, the color wheel rotating and having a plurality of color regions;
displaying an image using the color light at a display unit; and
supplying power to at least one of the light source and the wheel unit,
wherein the converting the emitted light into color light comprises:
controlling a rotation of the color wheel so that the plurality of color regions are synchronized with color information included in an image signal; and
the supplying power comprises:
not supplying power to at least one of the light source, the wheel unit and the display unit if the plurality of color regions are not synchronized with the color information for more than a reference time.

7. The method according to claim 6 further comprising detecting at least one of a frequency and a phase of the color wheel, and determining that the plurality color regions are not synchronized with the color information if the frequency and the phase of the color wheel are not detected.

8. The method according to claim 7, wherein the reference time is in a range from 80 ms to 120 ms if the color wheel rotates 14,000 to 15,000 times per minute.

9. The method according to claim 6, wherein t the reference time does not comprise a stabilization time due to a change of an image signal source or a channel.

10. The method according to claim 6 further comprising:
receiving power at a signal processor;
processing the image signal at the signal processor;
selectively projecting the color light based on the color information of the processed image signal using a digital micromirror device (DMD), to the display unit.

11. The method according to claim 10, the supplying power further comprising not supplying power to at least one of the signal processor and the DMD if the plurality color regions are not synchronized with the color information for more than the reference time.

12. The image display apparatus according to claim 1, wherein the color information includes information about the plurality of color regions corresponding to red, green and blue.

13. The image display apparatus according to claim 1, wherein the rotation of the color wheel is about an axis parallel to a path of the light emitted by the light source.

14. The image display apparatus according to claim 1, wherein the color wheel includes a mark on a lateral side of the color wheel for detecting the rotation of the color wheel.

15. The image display apparatus according to claim 1, wherein the detector further comprises a photo reflector.

16. The method according to claim 6, wherein controlling the rotation of the color wheel comprises controlling the rotation based on rotation information gathered by detecting light output by a photo reflector and reflected by a mark on the color wheel.
